(19) United States
(12) Patent Application Publication
(10) Pub. No.: US 2013/0043337 A1
(43) Pub. Date: Feb. 21, 2013

(54) APPARATUS FOR CONTROLLING THE BLENDING OF DRINKS

(71) Applicants: Steve Rukavina, Rocky River, OH (US); Tyrone Manhoff, North Olmsted, OH (US); Michael Arnett, Olmsted Township, OH (US)

(72) Inventors: Steve Rukavina, Rocky River, OH (US); Tyrone Manhoff, North Olmsted, OH (US); Michael Arnett, Olmsted Township, OH (US)

(21) Appl. No.: 13/586,574

(22) Filed: Aug. 15, 2012

Related U.S. Application Data
(60) Provisional application No. 61/523,676, filed on Aug. 15, 2011.

(51) Int. Cl. A47J 31/40; A47J 31/44

(52) U.S. Cl. 241/68; 241/101.3; 241/285.3; 241/285.1

(57) ABSTRACT

A blending system includes a base, a housing connected to the base, and an ice bin positioned above the housing. A plurality of load cells may be positioned between the housing and the ice bin to monitor the weight of the ice bin. A drive play may be positioned above the base with a plurality of load cells disposed between the drive plate and base to monitor the weight of a container positioned on the drive plate.

### CROSS-REFERENCE TO RELATED APPLICATIONS

This application claims benefit from U.S. Provisional Patent Application No. 61/523,676, entitled “Apparatus for Controlling the Blending of Drinks,” filed on Aug. 15, 2011, which is hereby incorporated in its entirety by reference.

### FIELD OF THE INVENTION

The present invention generally relates to blenders and, more particularly, to apparatus for controlling the blending of drinks.

### BACKGROUND

Very popular beverages today are those commonly referred to as “frozen” drinks, whereby a portion of liquid, which may often include a quantity of liquor and/or a flavored drink mix, and a portion of ice may be mixed together in a blending apparatus or blender to create an almost slush-like drink. In the past, the most typical manner to create such drinks may have required an operator to put a quantity of liquor, flavored drink mix, ice, and possibly other ingredients, such as fruit and the like, in the pitcher of a blender, and, thereafter, operate the blender until the frozen drink is perceived to be adequately mixed. The frozen drink may then be transferred from the pitcher of the blender to a patron's glass for consumption.

Such a procedure may have many disadvantages. For example, this procedure, in the sometimes busy environment of some establishments, may require the constant attention of the operator. Instead of operating the blender, the operator could be giving his or her attention to making other drinks while the frozen drink is being prepared.

Moreover, in the above-described manner, a skilled operator may have difficulty making frozen drinks which are consistent in quantity and quality. That is, dependent on the number of drinks to be made, the operator may be required to estimate the proper portions of liquid and ice to mix in the blender. If too small a quantity of liquid and ice are blended, the patron's glass will not be filled on the first try, and the operator will be required to blend additional portions of liquid and ice. Or, as often is the case, the operator may blend too large a quantity of liquid and ice, which, if not eventually used, is wasteful to the economic detriment of the establishment. Furthermore, there is no way to assure that the quality of the drink is consistent from drink-to-drink. If patrons have enjoyed a good first drink, they expect that their second drink will be of the same quality, which cannot always happen when the operator is required to “eyeball” the portion of liquid relative to the portion of ice to be blended.

In typical devices, attempts may be made to control the amount of ice to be delivered to the blending container by operating an ice shaver for a predetermined amount of time. Then, after a predetermined time delay, the blender may operate for a preselected amount of time. However, repeatably consistent drinks cannot be made by such a device in that there is no correlation between the amount of liquid which is manually placed in the container of the blender and the amount of ice to be delivered.

Alternatively, using time as the operative control parameter does not assure that the correct or precise quantity of ice has been added. For example, the ice machine might be almost empty, thereby not having a sufficient quantity of ice for the drink, yet these types of devices would run for a predetermined time and deliver an incorrect quantity of ice. Moreover, even if there was sufficient ice in the machine, it may not always be delivered at a uniform rate and it might not even be delivered at all, as could happen if the ice delivering blades were operating in a dead air space created by an arching of the ice in the machine.

### SUMMARY

A blending system is provided, including a base, a housing connected to the base, and an ice bin positioned above the housing. A plurality of load cells, such as three or more, may be positioned between the housing and the ice bin. In an embodiment, the load cells may be positioned on a shaver base positioned between the housing and the ice bin. The blending system may monitor the load cells to determine changes in weight of the ice bin.

In an embodiment, the blending system may include a drive plate positioned above the base. The drive plate may be configured to support a container thereon. A plurality of load cells, such as three or more load cells, may be positioned between the base and the drive plate. The blending system may monitor the load cells to determine changes in the weight of the container.

In an embodiment, the blending system may include a shaver wheel in the ice bin having an opening therein. The opening may be in fluid communication with one or more drain apertures in a shroud positioned on the base.

In an embodiment, the blending system may include a shroud positioned on the base. The shroud may include at least one open side. A front door may be positioned about the open side of the shroud and connected to hinges positioned on either side of the open side. The front door may be opened from either side and may pivot from either hinge.

In an embodiment, the blending system includes a drive plate having a pivot point, a retaining member and a thumb screw. A motor mount may be positioned on the pivot point, attached to the retaining member and secured into position by the thumb screw. A spring may be positioned to connect the drive plate and the motor mount.

### BRIEF DESCRIPTION OF THE DRAWINGS

Objects and advantages together with the operation of the invention may be better understood by reference to the following detailed description taken in connection with the following illustrations, wherein:

FIG. 1 illustrates a perspective view of a blending apparatus in an embodiment of the present invention.

FIG. 2 illustrates a side view of the blending apparatus of FIG. 1.

FIG. 3 illustrates a front view of the blending apparatus of FIG. 1.

FIG. 4 illustrates a perspective view of an embodiment of the blending apparatus of FIG. 1 with a door in an open position.

FIG. 5 illustrates a partial exploded perspective view of the blending apparatus of FIG. 1.

FIG. 6A illustrates a partial exploded perspective view of a shaver base and lid of the blending apparatus of FIG. 5.

FIG. 6B illustrates a partial exploded perspective view of an ice bin of the blending apparatus of FIG. 6A.

FIG. 7 illustrates a rear perspective view of a container housing and motor of the blending apparatus of FIG. 5.

FIG. 8 illustrates a partial exploded perspective view of the container housing and motor of FIG. 7.

FIG. 9 illustrates a cross-sectional perspective view of the blending apparatus taken along line 9-9 of FIG. 3.

FIG. 10 illustrates a cross-sectional perspective view of the blending apparatus taken along line 10-10 of FIG. 3.

FIG. 11 illustrates a perspective view of a blending apparatus with a door in a closed position in an embodiment of the present invention.

FIG. 12 illustrates a perspective view of the blending apparatus of FIG. 11 with the door in an open position.

FIG. 13 illustrates a view of the drive plate tensioning system.

FIG. 14 illustrates a view of a mechanically hinged door.

FIG. 15 illustrates a cross-sectional view of a mechanically hinged door.

FIG. 16 illustrates a shaver base with dampers.

FIG. 17 illustrates a base plate with dampers.

FIG. 18 illustrates a base plate with a collection tray.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

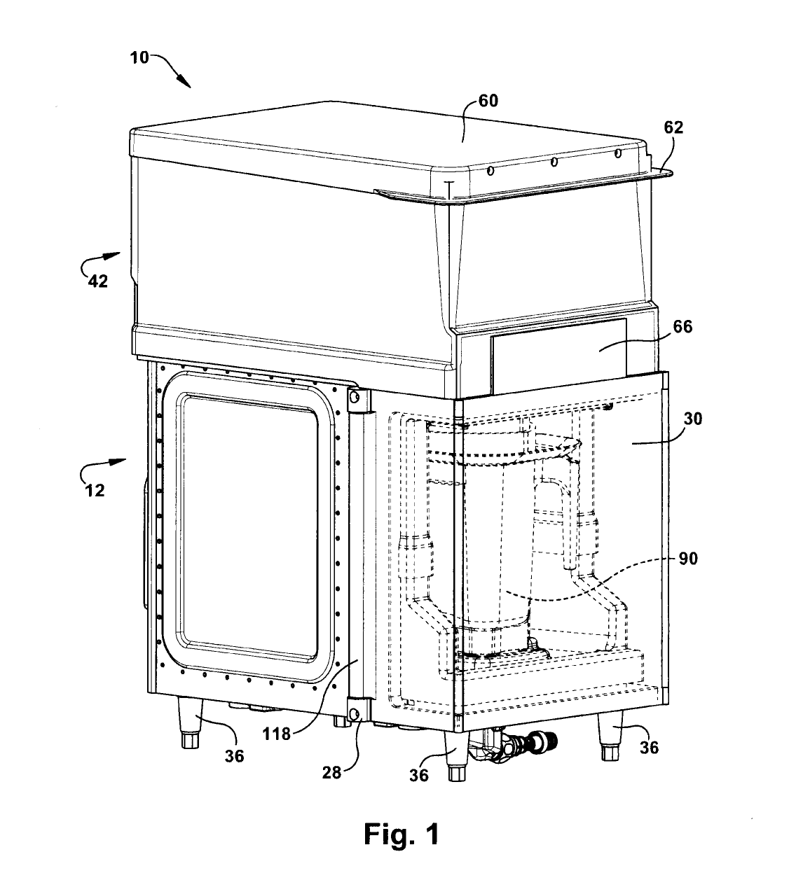

A blending apparatus 10 is illustrated in FIGS. 1-5 and 9-12. The blending apparatus 10 may be of any appropriate shape, size, type or configuration. The blending apparatus 10 may be utilized for any appropriate purpose. For example, the blending apparatus 10 may be utilized to make a blended ice beverage, such as a drink made with a portion of liquid and a portion of ice, as may often be prepared and served in restaurants, cocktail lounges, or the like. The blending apparatus 10 may precisely control the portions of the drink so as to provide repeated, consistent drinks The blending apparatus 10 may include a housing 12, a front door 30, a shaver base 42, and a lid 60 (FIGS. 1-5).

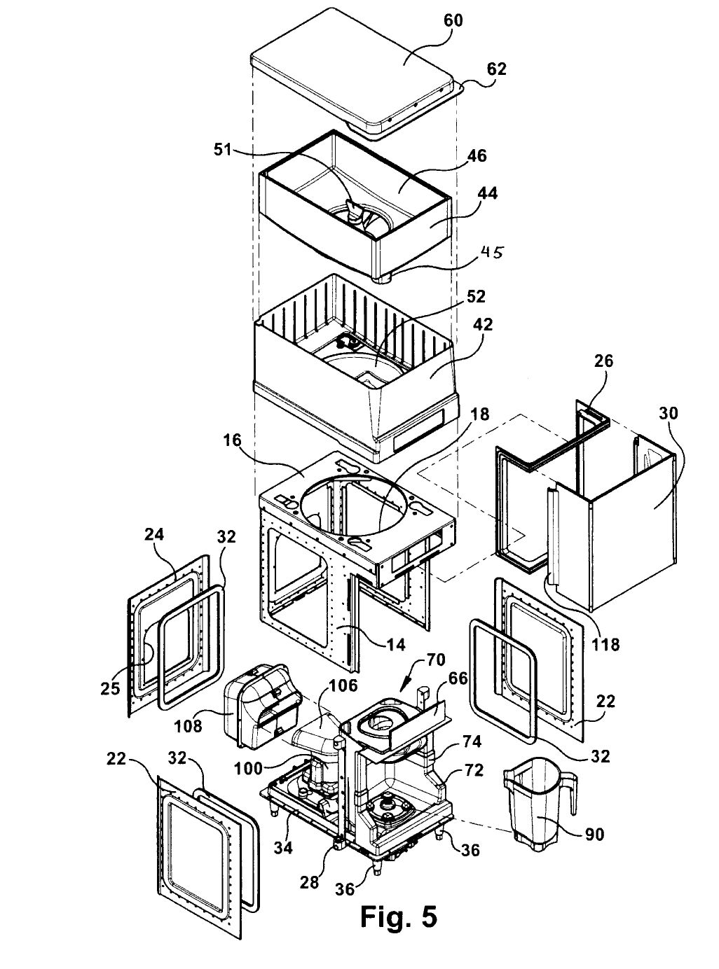

The housing 12 may include a frame 14, a top frame 16, a pair of side panels 22, a back panel 24 and a base plate 34 (FIG. 5). The frame 14 may be of any appropriate shape, size, type or configuration, such as of a generally hollow square or rectangular configuration with multiple large openings for the panels 22, 24 (FIG. 5). The frame 14 may be located at any appropriate position on the blending apparatus 10, such as at a generally central location on the blending apparatus 10.

The top frame 16 may be of any appropriate shape, size, type or configuration, such as of a generally hollow rectangular configuration. The top frame 16 may be located at any appropriate position on the blending apparatus 10, such as located above the frame 14 (FIG. 5). The top frame 16 may include a central aperture 18 and at least one mounting aperture (FIG. 5).

The central aperture 18 may be of any appropriate shape, size, type or configuration, such as of a generally circular shape. The central aperture 18 may be located at any appropriate position on the top frame 16, such as at an approximate central location on the top frame 16. The top frame 16 may include any appropriate number of mounting apertures, such as four mounting apertures. The mounting apertures may be located at any appropriate position on the top frame 16, such as located adjacent each corner of the top frame 16 (FIG. 5).

There may be any appropriate number of side panels 22, such as a pair of side panels 22. The side panels 22 may be of any appropriate shape, size, type or configuration, such as of a generally rectangular or square planar configuration. The side panels 22 may be located at any appropriate position on the blending apparatus 10, such as generally located on each side of the frame 14 (FIG. 5).

The back panel 24 may be of any appropriate shape, size, type or configuration, such as of a generally rectangular or square planar configuration. The back panel 24 may be located at any appropriate position on the blending apparatus 10, such as located behind the frame 14 (FIG. 5). The back panel 24 may include an aperture 25 (FIG. 5). The aperture 25 may be of any appropriate shape, size, type or configuration, such as of a generally rectangular or square configuration. The aperture 25 may be located at any appropriate position on the back panel 24, such as at the approximate center of the back panel 24.

The base plate 34 may be of any appropriate shape, size, type or configuration, such as of a generally square or rectangular configuration. The base plate 34 may be located at any appropriate position on the blending apparatus 10, such as located below the frame 14 (FIGS. 5 and 7-9). The base plate 34 may include at least one leg 36 (FIGS. 5 and 7-9). The base plate 34 may include any appropriate number of legs 36, such as four legs 36. The legs 36 may be of any appropriate shape, size, type or configuration, such as a generally cylindrical or rectangular tubular configuration. The legs 36 may be located at any appropriate position on the base plate 34, such as located adjacent each corner of the base plate 34 and extending outwardly from the base plate 34.

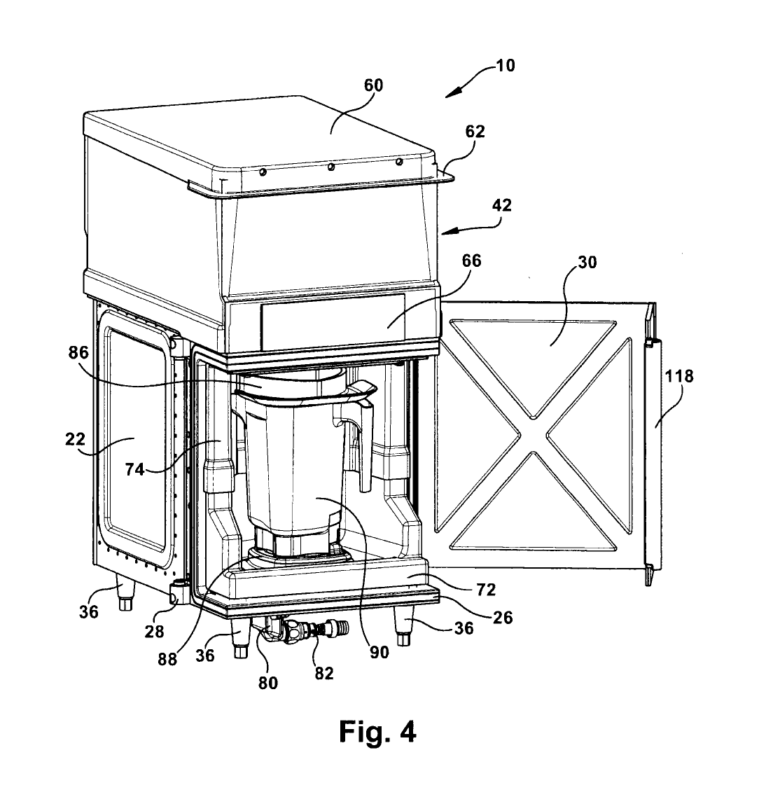

The housing 12 may also include a door gasket 26 and at least one panel seal 32 (FIG. 5). The door gasket 26 may be of any appropriate shape, size, type or configuration, such as of a generally planar configuration. For example, the door gasket 26 may act as a form of door frame for the door 30 (FIGS. 4, 5, 9 and 10). The door gasket 26 may also provide a seal between the housing 12 and the door 30. The door gasket 26 may be located at any appropriate position on the housing 12, such as towards the front of the frame 14 and near the bottom front of the top frame 16 (FIG. 5).

The housing 12 may include any appropriate number of panel seals 32, such as three panel seals 32 (FIG. 5). The panel seals 32 may be of any appropriate shape, size, type or configuration, such as of a generally square or rectangular configuration. For example, the panel seals 32 may be formed into a generally tubular square or rectangular shape. The panel seals 32 may be located at any appropriate position on the housing 12, such as located between the frame 14 and each side panel 22 and between the frame 14 and the back panel 24 (FIG. 5). The panel seals 32 may provide a sealed relationship between the frame 14 and panels 22, 24.

The door 30 may be of any appropriate shape, size, type or configuration, such as of a generally C-shaped or U-shaped configuration (FIGS. 1, 2, 4, 5, 11 and 12). The u-shaped door may include a central portion and two side portions. The side portions may be moveable with respect to the central portion, such as connected to the central portion by a hinge. The door 30 may be of a configuration that may be easily removed and cleaned. The door 30 may be located at any appropriate position on the blending apparatus 10, such as towards the front of the blending apparatus 10 and abutted or adjacent to the door gasket 26 of the housing 12 (FIG. 5). The door 30 may be fabricated out of any appropriate type of material, such that the door may be translucent.

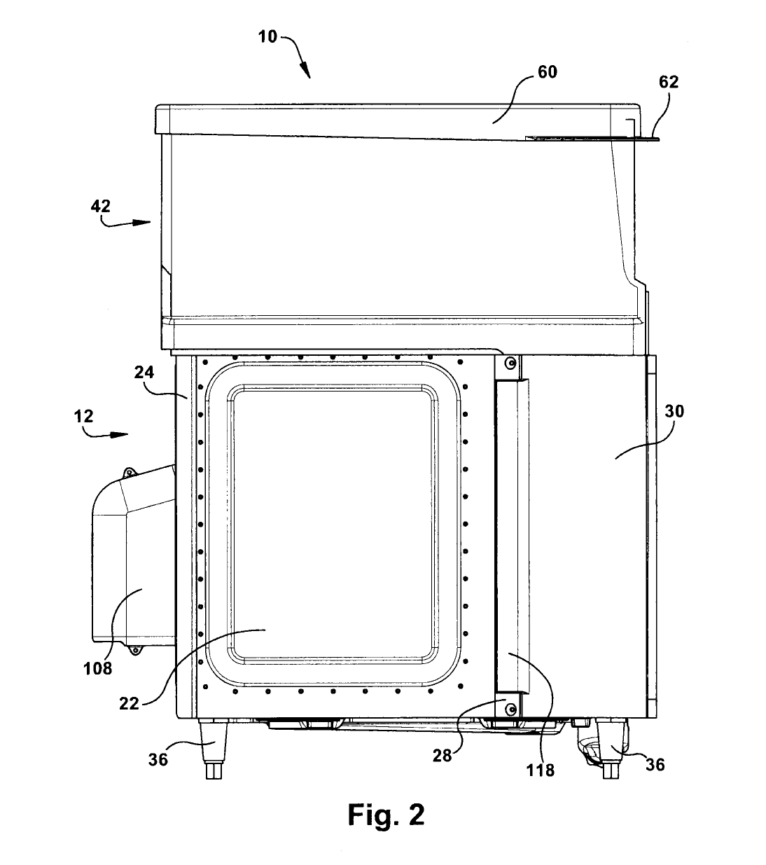

The door 30 may include at least one attachment feature 118 (FIGS. 2-5). The door 30 may include any appropriate number of attachment features 118, such as a pair of attachment features 118. The attachment features 118 may be of any appropriate shape, size, type or configuration, such as a generally curved rectangular configuration. The attachment feature 118 may be located at any appropriate position on the door 30, such as located on and edge of each side of the door 30.

The blending apparatus 10 may include at least one door hinge 28 (FIGS. 2-5 and 7). The blending apparatus 10 may include any appropriate number of hinges 28, such as a pair of hinges 28. The hinges 28 may be of any appropriate shape, size, type or configuration, such as a generally rectangular planar configuration with a cylindrical member located on each end. The cylindrical members may be of any appropriate type or configuration, such as a magnetic configuration. The hinges 28 may be located at any appropriate position on the blending apparatus 10, such as located on each side of the housing adjacent to the door gasket 26.

In this embodiment, the door 30 may utilize magnetic hinges. The magnets located within the hinges 28 may lock each side of the door 30 in place. The magnetic hinges 28 may also act as a hinge, whereby the door 30 may open to either side or be pulled completely off from the front (FIG. 4). The door 30 may also utilize at least one handle (not shown). There may be any appropriate number of handles and the handles may be located at any appropriate position on the door 30. In another embodiment, the handle may include an actuator (not shown). Again, the door 30 may be pulled off from the front or to one side or the other. The handle may be squeezed to actuate a lever (not shown) to open the door 30.

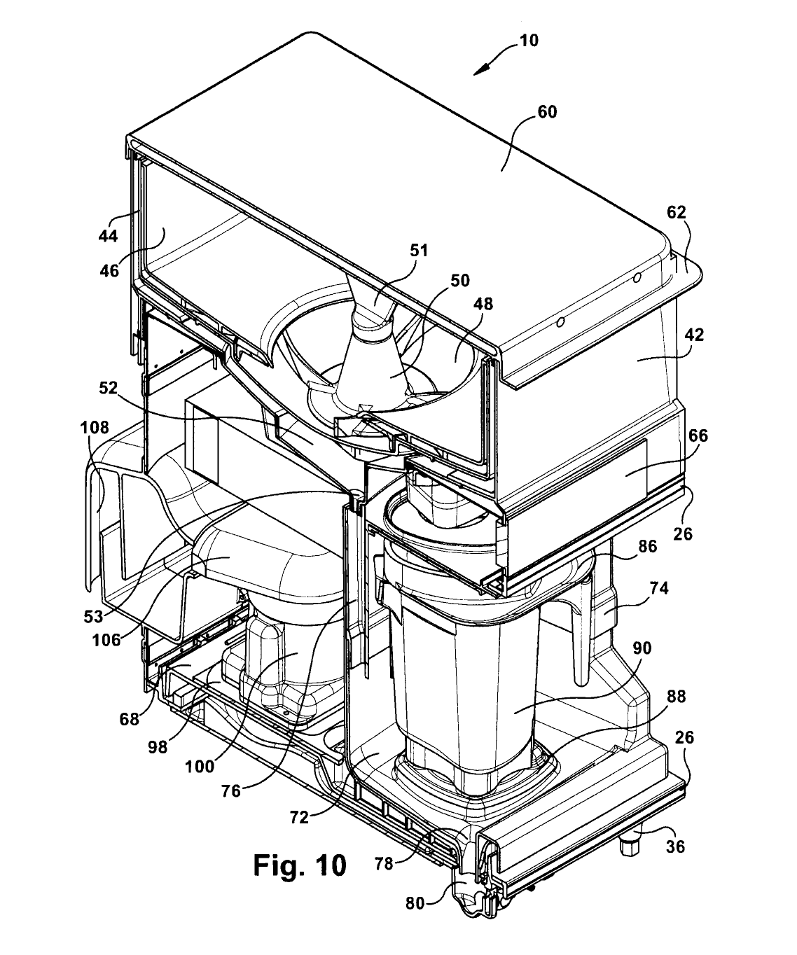

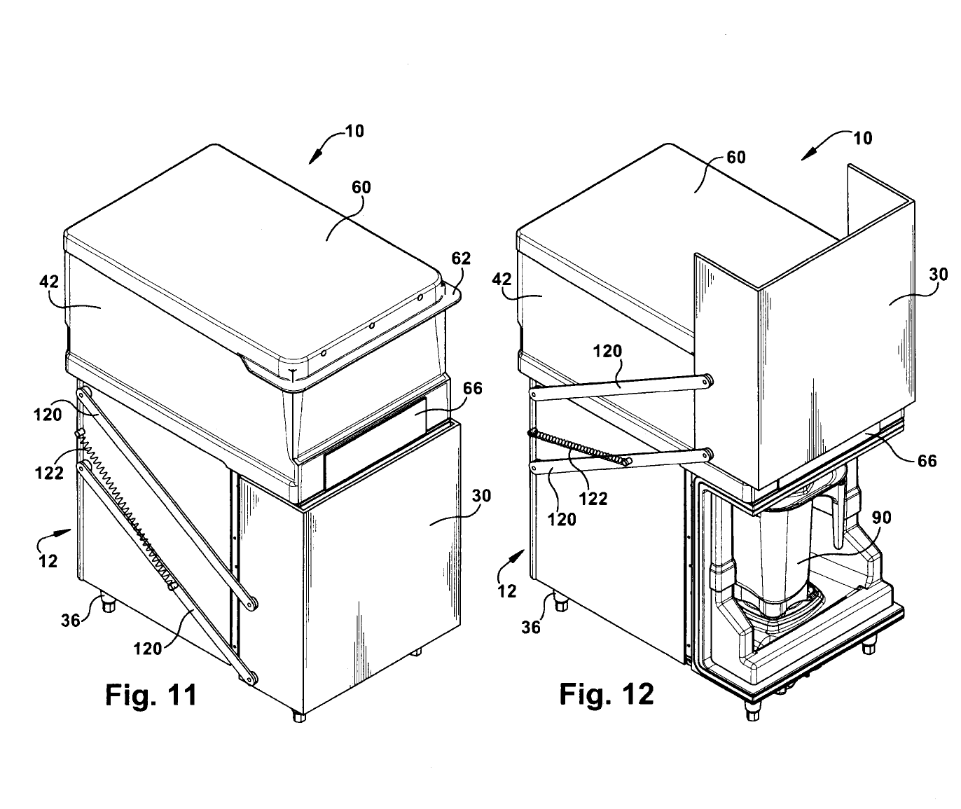

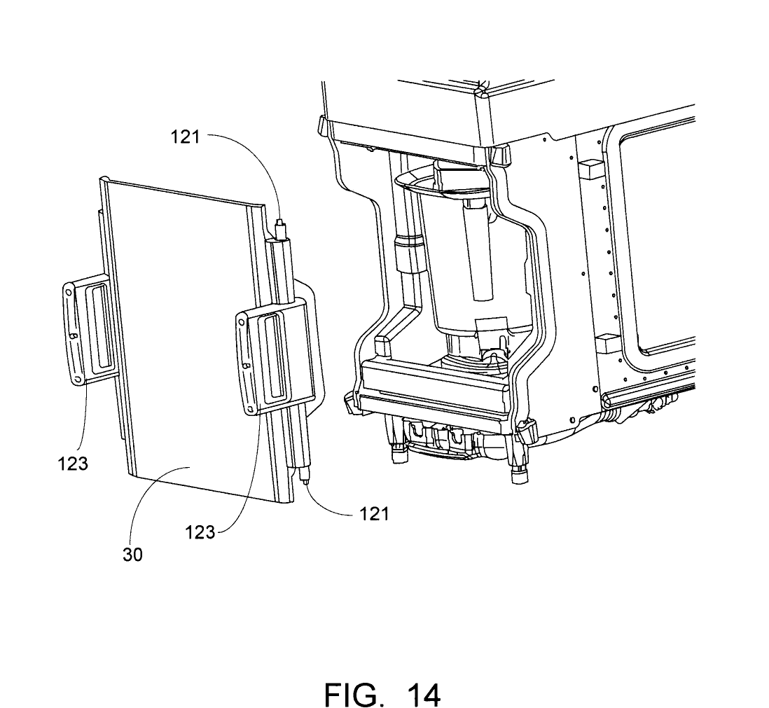

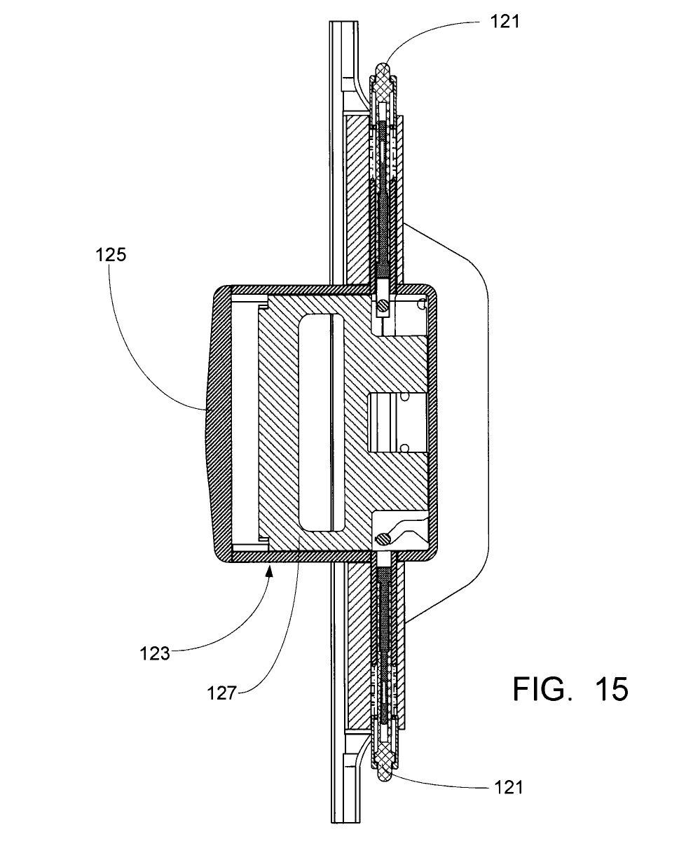

In an alternative embodiment, the door 30 may be hinged or spring loaded, whereby the door 30 may be pulled up or lifted up to open (FIGS. 11 and 12). The door 30 may include at least one bracket 120 and a spring 122 (FIGS. 11 and 12). For example, the door 30 may utilized a pair of brackets 120. The brackets 120 may be secured to each side of the door and a rear portion of the housing 12. The spring 122 may be secured to a portion of one of the brackets 120 and a rear portion of the housing 12. The door 30 may utilize a handle, whereby the handle may be located at any appropriate position on the door 30, such as in the approximate middle of the door 30. In the mechanical hinge configuration (FIGS. 14 and 15) the door may include spring loaded rods 121 on both ends of the door. Each set of spring loaded rods 121 may be connected to a triggering handle 123. The triggering handle 123 may comprise an outer portion 125 and an inner portion 127 moveable with respect to the outer portion 125. Movement of the inner handle portion 127 may cause compression of the springs to move the rod 121 out of connection with the hinge. The door may then be pivoted about the opposite hinge.

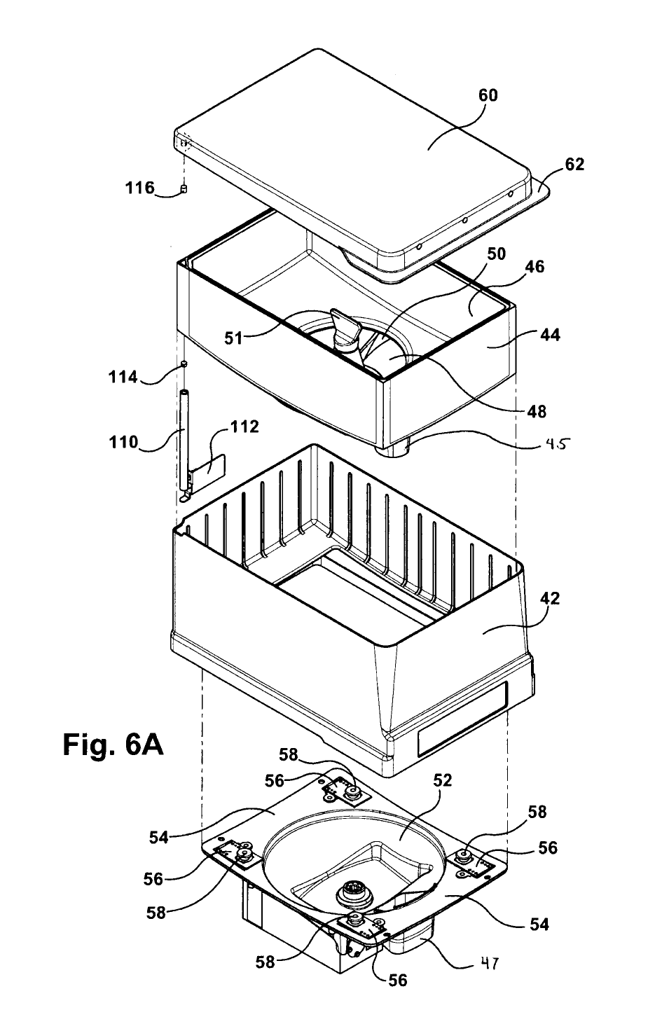

The shaver base 42 may be of any appropriate shape, size, type or configuration, such as of a generally rectangular or square configuration. For example, the shaver base 42 may generally be a four sided hollow box (FIGS. 5-6B). The shaver base 42 may be located at any appropriate position on the blending apparatus 10, such as generally located above and atop the top frame 16 of the housing 12 (FIG. 5).

The shaver base 42 may include an ice bin 44 (FIGS. 5-6B). The ice bin 44 may be of any appropriate shape, size, type or configuration, such as of a generally square or rectangular configuration. For example, the ice bin 44 may generally be of a correspondingly similar shape and size as that of the shaver base 42. The ice bin 44 may be located at any appropriate position on the shaver base 42, such as located within the shaver base 42.

The ice bin 44 may include any appropriate number of walled layers, such as a plurality of walls or walled layers. For example, the ice bin 44 may be a double walled ice bin 44, whereby the ice bin 44 may also include a bin liner 46 (FIGS. 5-6B). The shaver base 42 may act as a third wall. The bin liner 46 may be of any appropriate shape, size, type or configuration, such as of a generally correspondingly similar shape and size as that of the ice bin 44. The bin liner 46 may be located at any appropriate position, such as located within the ice bin 44. The double walled ice bin 44, that is, the ice bin 44 and the bin liner 46, for example, may prolong the ice located within the ice bin 44 from melting. The ice bin 44 may let any excess melted water escape from a bottom of the ice bin 44.

The lid 60 may be of any appropriate shape, size, type or configuration, such as of a generally rectangular and planar configuration. The lid 60 may be located at any appropriate position on the blending apparatus 10, such as located above the shaver base 42 (FIGS. 1-6B and 9-12). The lid 60 may cover and enclose a top opening of the shaver base 42. The lid 60 may include a flange 62.

The flange 62 may be of any appropriate shape, size, type or configuration, such as of a generally planar configuration. The flange 62 may be located at any appropriate position on the lid 60, such as located adjacent to or along a portion of an edge of the lid 60 (FIGS. 1-6B and 9-12). The flange 62 may be located along any portion or the entire perimeter of the lid 60. The flange 62 may aid an operator of the blending apparatus 10 to easily open and shut the lid 60.

The blending apparatus 10 may also include a control panel 66 (FIGS. 1, 3-5 and 9-12). The control panel 66 may be of any appropriate shape, size, type or configuration, such as a generally square or rectangular configuration. For example, the control panel 66 may be a touch panel. The control panel 66 may be located at any appropriate position on the blending apparatus 10, such as located on the lower front of the shaver base 42 (FIGS. 1, 3-5 and 9-12). The control panel 66 may be utilized for any appropriate purpose, such as to set and control the operation of the blending apparatus 10.

The blending apparatus 10 may include a shaver 52 (FIGS. 5-6A, 9 and 10). The shaver 52 may be of any appropriate shape, size, type or configuration. The shaver 52 may be located at any appropriate position on the blending apparatus 10, such as generally located between the shaver base 42 and the housing 12, whereby the shaver base 42 may be mounted on top of the shaver 52. For example, the shaver 52 and the shaver base 42 may be mounted and assembled together, whereby the shaver 52 and shaver base 42 may act as one part. The shaver 52 may be fabricated out of any appropriate materials or process, such as being an aluminum or metal casting. The shaver base 42 may be fabricated out of any appropriate materials or process, such as being a plastic and transparent component.

The ice bin 44 may include an ice funnel 48 and a shaver wheel 50 (FIGS. 5-6B, 9 and 10). The ice funnel 48 may be of any appropriate shape, size, type or configuration, such as of a generally square or rectangular and curved configuration. The ice funnel 48 may be located at any appropriate position, such as located between a central location on the shaver 52 and the ice bin 44 (FIGS. 5-6B, 9 and 10). The ice bin 44 and the ice funnel 48 may be mounted and assembled together. The ice bin 44 may be fabricated out of any appropriate materials or process, such as of a transparent and plastic material. The ice funnel 48 may be fabricated out of any appropriate materials or process, such as being a metal casting.

The shaver wheel 50 may be of any appropriate shape, size, type or configuration, such as of a generally circular configuration. The shaver wheel 50 may be located at any appropriate position on the ice bin 44, such as generally located above and at a central location to the ice bin 44 and positioned within the ice funnel 48 (FIGS. 5-6B, 9 and 10). The shaver wheel 50 may rotate with respect to the ice funnel 48 to move the ice along a shaver blade and shave the ice to a desired thickness.

The shaver wheel 50 may move the shaved ice to help it exit the ice bin 44. For example, the ice bin 44 may include an ice chute 45 (FIGS. 5, 6A and 6B). The ice chute 45 may be of any appropriate shape, size, type or configuration and located at any appropriate position on the blending apparatus 10, such as generally at a bottom portion of the ice bin 44. The ice chute 45 may comprise a generally tubular opening to allow ice to exit the ice bin 44. It will be appreciated, however, that the ice chute 45 may be any type of opening configured to allow ice to exit the ice bin 44. The ice chute 45 may be sized, shaped and positioned to align with a pass-through portion 47 of the shaver 52. The pass-through portion 47 may generally surround the ice chute 45. In an embodiment, a spatial gap is maintained between the ice chute 45 and the pass-through portion 47 to provide isolation of the ice bin 44 and shaver 52 from other portions of the blending apparatus 10.

The shaver wheel 50 may include a paddle nut 51 (FIGS. 5-6B, 9 and 10). The paddle nut 51 may be of any appropriate shape, size, type or configuration, such as of a generally triangular or rectangular configuration. The paddle nut 51 may be located at any appropriate position on the shaver wheel 50, such as atop a generally central location of the shaver wheel 50. The paddle nut 52 may connect the shaver wheel 50 to a shaft that is capable of rotation with respect to the ice funnel 48 and may be driven to rotate by a shaver motor.

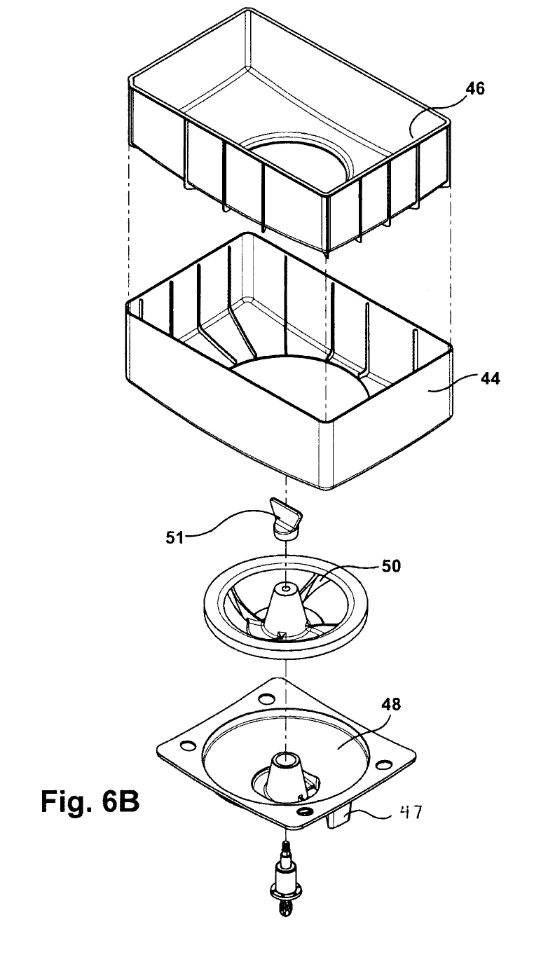

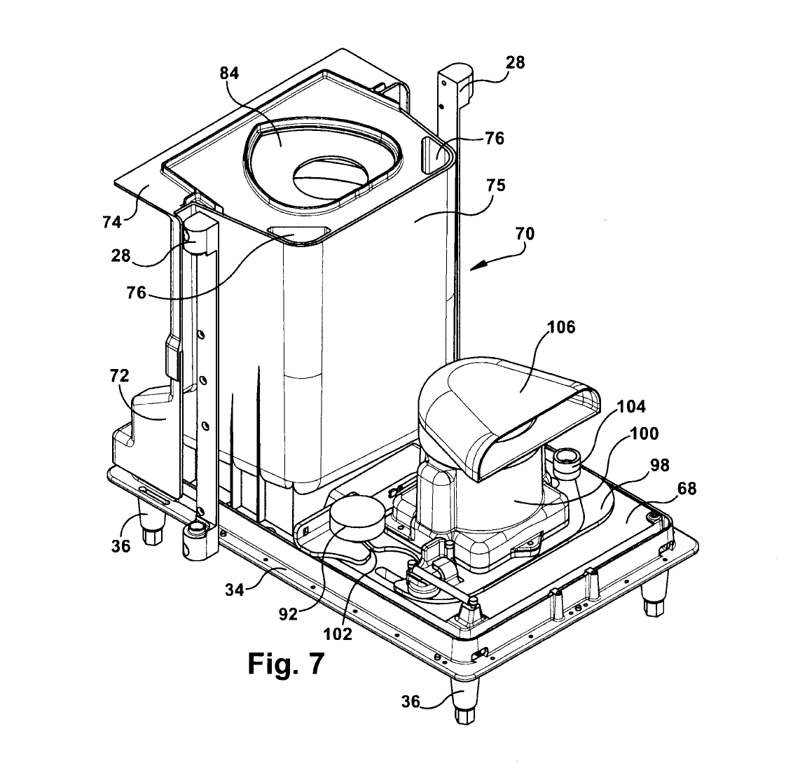

The blending apparatus 10 may include a container housing 70 (FIGS. 5, 7 and 8). The container housing 70 may be of any appropriate shape, size, type or configuration. The container housing 70 may be located at any appropriate position on the blending apparatus 10, such as within the housing 12 and adjacent the door gasket 26. The container housing 70 may include a bottom liner 72, a top liner 74 and a container shroud 75 (FIGS. 7 and 8). The container shroud 75 may be mounted to the drive plate 68, whereby the container shroud 75 may act as a support structure to support the bottom liner 72 and the top liner 74.

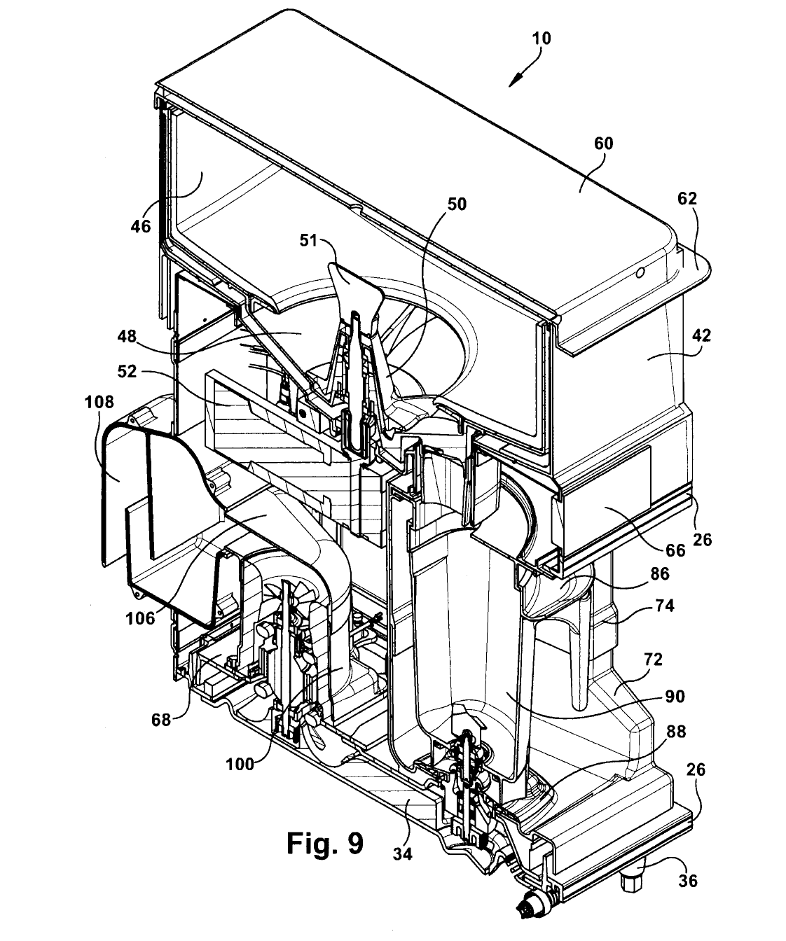

The bottom liner 72 may be of any appropriate shape, size, type or configuration, such as of a generally C-shaped or U-shaped configuration. The bottom liner 72 may be located at any appropriate position on the blending apparatus 10, such as beneath the top liner 74 and above the base plate 34 (FIGS. 5 and 7-10). The bottom liner 72 may include a drain 78 (FIG. 10). The drain 78 may be of any appropriate shape, size, type or configuration, such as a generally cylindrical configuration. The drain 78 may be located at any appropriate position on the bottom liner 72, such as adjacent a front corner of the bottom liner 72. The drain 78 may provide access through and underneath the base plate 34 (FIG. 10).

The top liner 74 may be of any appropriate shape, size, type or configuration, such as of a generally C-shaped or U-shaped configuration. The top liner 74 may be located at any appropriate position on the blending apparatus 10, such as above the bottom liner 72 and beneath a portion of the shaver base 42 (FIGS. 5 and 7-10). The top liner 74 may include at least one drain aperture 76.

The top liner 74 may include any appropriate number of drain apertures 76, such as a pair of drain apertures 76 (FIGS. 7 and 8). The drain apertures 76 may be of any appropriate shape, size, type or configuration, such as of a generally triangular configuration. The drain apertures 76 may be located at any appropriate position on the top liner 74, such as adjacent the rear corners of the top liner 74 near the container shroud 75.

The container shroud 75 may be of any appropriate shape, size, type or configuration, such as of a generally C-shaped or U-shaped configuration. The shroud 75 may include at least one open side, as illustrated in the figures. The open side may be covered by the front door 30. The opening of the open side may further extend to portions of the sides of the container shroud 75, as illustrated. The shroud 75 may be located at any appropriate position on the container housing 70, such as adjacent the bottom liner 74 and top liner 72 and located above the base plate 34 (FIGS. 7 and 8).

The shaver 52 may include at least one shaver drain 53, such as a pair of drains 53. The shaver drains 53 may be of any appropriate shape, size, type or configuration, such as of a generally cylindrical configuration. The shaver drains 53 may be located at any appropriate position on the shaver 52, such as aligned with the drain apertures 76 of the top liner 74 (FIG. 10). The shaver drains 53 may provide access through the shaver 52 and into the drain apertures 76 of the top liner 74 (FIG. 10).

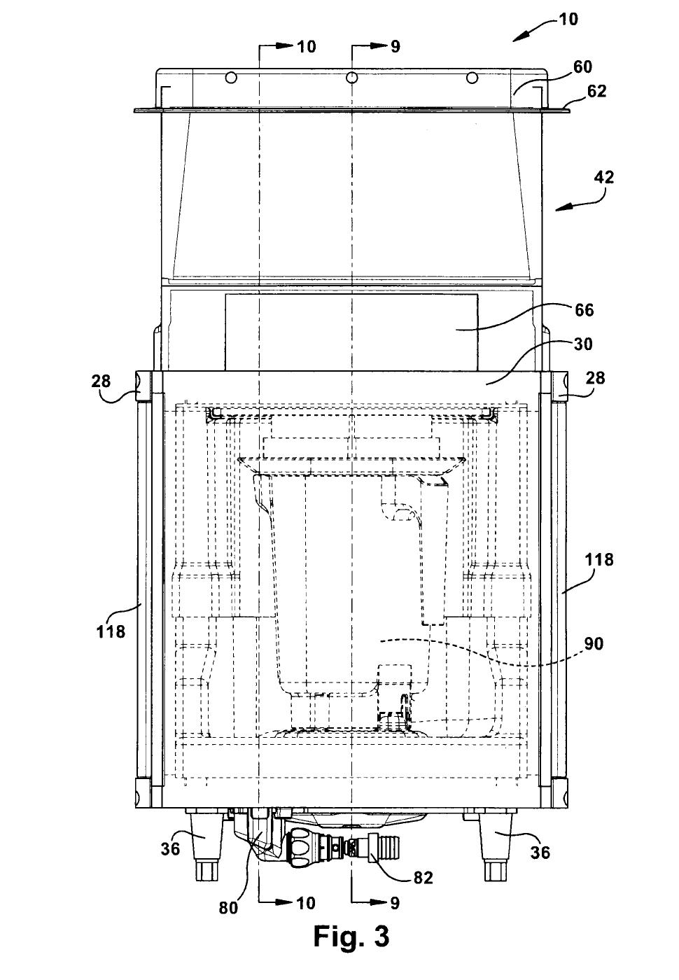

The blending apparatus 10 may include a drain cup 80 and a drain coupling 82 (FIGS. 3 and 4). The drain cup 80 may be of any appropriate shape, size, type or configuration, such as of a generally cylindrical configuration. The drain cup 80 may be located at any appropriate position on the blending apparatus 10, such as below the base plate 34 and aligned with the drain 78 of the bottom liner 72 (FIG. 10).

The drain coupling 82 may be of any appropriate shape, size, type or configuration, such that the drain coupler 82 may be coupled to a hose or tube (not shown). The drain coupling 82 may be located at any appropriate position on the blending apparatus 10, such as attached to the drain cup 80 and located beneath the base plate 34 (FIGS. 3 and 4).

Any water resulting from melted ice within the blending apparatus 10 may be drained from the ice bin 44, through the funnel 48, down trough the drain 53 located in the shaver 52, into the aperture 76 of the top liner 74, down the back of the bottom liner 72 and through the drain 78 of the bottom liner 72 to the drain cup 80 (FIG. 10). Once the water is in the drain cup 80, the water may be removed via the external and removably connected hose or tube.

The container housing 70 may include a splash mount 84 and a splash guard 86. The splash mount 84 may be of any appropriate shape, size, type or configuration, such as of a generally circular, triangular or square configuration. The splash mount 84 may be located at any appropriate position on the container housing 70, such as adjacent to a top end of the top liner 74 (FIGS. 7 and 8). The splash guard 86 may be of any appropriate shape, size, type or configuration, such as of a generally cylindrical and curved configuration. The splash guard 86 may be located at any appropriate position on the container housing 70, such as adjacent the top end of the top liner 74 and adjacent the splash mount 84 (FIGS. 4, 9 and 10).

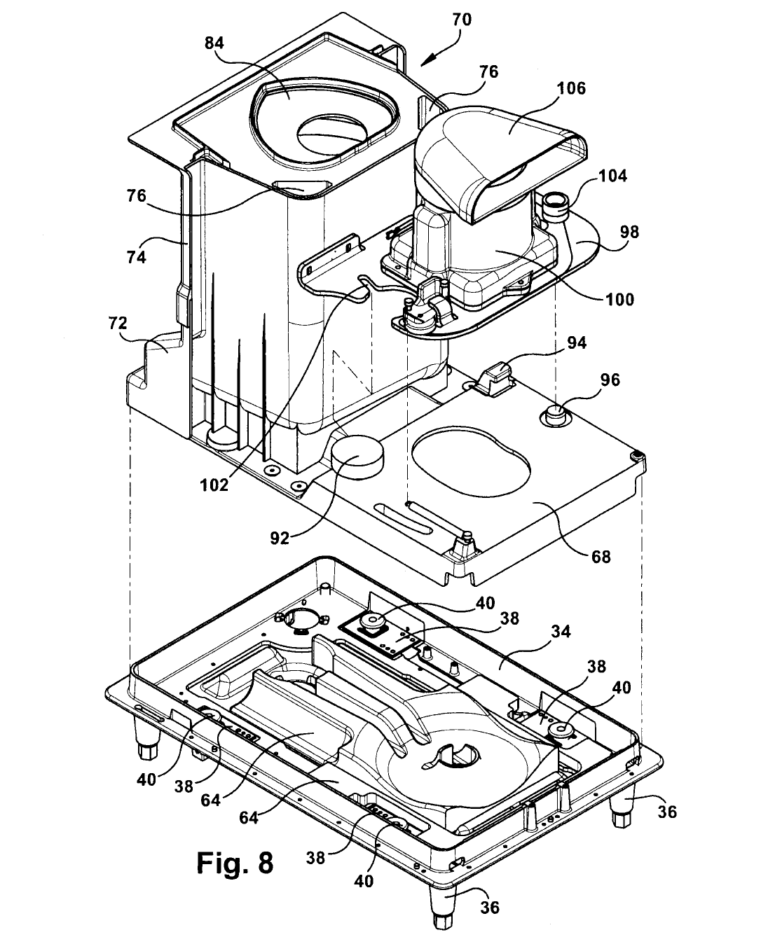

The container housing 70 may include a container pad 88 and a container 90 (FIGS. 4, 9 and 10). The container pad 88 may be of any appropriate shape, size, type or configuration, such as of a generally square configuration. The container pad 88 may be located at any appropriate position on the container housing 70, such as located on the bottom liner 72 (FIGS. 9 and 10). The container pad 88 may aid in locating the container 90 within the container housing 70.

The container 90 may be of any appropriate shape, size, type or configuration, such as of a generally multi-walled configuration with an upper open end. The container 90 may be located at any appropriate position on the container housing 70, such as adjacent to and within the bottom liner 72 and the top liner 74 (FIGS. 1, 3-5, 9 and 10). For example, a lower end of the container 90 may rest upon the container pad 88 and the upper open end of the container 90 may abut the splash guard 86. When the door 30 is in a closed position, the door 30 may enclose the container 90 within the housing 12 of the blending apparatus 10.

The blending apparatus 10 may include a drive plate 68 (FIGS. 7, 8 and 10). The drive plate 68 may be of any appropriate shape, size, type or configuration, such as of a generally rectangular or square planar configuration. The drive plate 68 may be located at any appropriate position on the blending apparatus 10, such as located above the base plate 34 and below the container housing 70.

The drive plate 68 may include a motor mount plate 98 (FIGS. 7, 8 and 10). The motor mount plate 98 may be of any appropriate shape, size, type or configuration, such as of a generally square or rectangular planar configuration. The motor mount plate 98 may be located at any appropriate position on the blending apparatus 10, such as above and towards and end of the drive plate 68, whereby the motor mount plate 98 may be located within the housing 12.

The base plate 34 may include at least one foam damper 64 (FIG. 8). The base plate 34 may include any appropriate number of foam dampers 64. The foam dampers 64 may be of any appropriate shape, size, type or configuration, such that the foam dampers 64 may fill in the desired space located between the base plate 34 and the drive plate 68.

The blending apparatus 10 may include an enclosure 108 (FIGS. 2, 5, 9 and 10). The enclosure 108 may be of any appropriate shape, size, type or configuration, such as of a generally square or rectangular configuration with an S-shaped aperture located within (FIGS. 9 and 10). The enclosure 108 may be located at any appropriate position on the blending apparatus 10, such as located within the aperture 25 of the back panel 24. The enclosure 108 may extend out from the housing 12 (FIGS. 2, 9 and 10). The enclosure 108 may increase the amount of air intake to the blending apparatus 10.

The blending apparatus 10 may include a motor 100 (FIGS. 5 and 7-10). The motor 100 may be of any appropriate shape, size, type or configuration. The motor 100 may be located at any appropriate position on the blending apparatus 10, such as located on the motor mount plate 98, whereby the motor 100 is located within the housing 12. The motor 100 may include an air tube 106.

The air tube 106 may be of any appropriate shape, size, type or configuration, such as of a generally triangular and tubular configuration. The air tube 106 may be located at any appropriate position, such as located on top of the motor 100 (FIGS. 5 and 7-10). For example, the air tube 106 may be located between and engage the motor 100 for cooling air flow purposes to the enclosure 108, whereby air may flow through the enclosure 108, along the S-shaped aperture through the air tube 106 to the motor 100.

The air tube 106 and the enclosure 108 may not be physically secured to one another. For example, the air tube 106 and the enclosure 108 may engage one anther while being physically disconnected from one another. The air tube 106 may be a part of the weighing sensor system, whereby the air tube 106 may be weighed, and the enclosure 108 may be mounted to the rigid structure, which may not be weighed. If the components were physically secured to each other, problems may result in terms of providing an accurate weighing system and reading the load cells.

The blending apparatus 10 may include a holding system for the motor 100 (FIGS. 7 and 8). The holding system may include a thumb screw 92, a slot 102 in the motor mounting plate 98, a pivot point 96 and a pivot bushing 104 (FIGS. 7 and 8). The holding system may provide for the motor 100 to be easily removed from the blending apparatus 10 for ease of service and ease of assembly. Typically, the motor 100 may be connected by grommets. The holding system may provide easy access to set belt tension consistently, which may create a big impact on the life of the motor 100 and its various components.

The thumb screw 92 may be of any appropriate shape, size, type or configuration, such as of a generally circular configuration. The thumb screw 92 may be located at any appropriate position, such as adjacent a side of the drive plate 68 (FIGS. 7 and 8). The slot 102 may be of any appropriate shape, size, type or configuration, such as of a generally oblong configuration. The slot 102 may be located at any appropriate position on the motor mount plate 98, such as adjacent a side of the motor mount plate 98 (FIG. 8). The thumb screw 92 may be rotated or slid out of the slot 102.

The pivot point 96 may be of any appropriate shape, size, type or configuration, such as of a generally cylindrical configuration. The pivot point 96 may be located at any appropriate position on the blending apparatus 10, such as located on and adjacent to a side of the drive plate 68 (FIG. 8). The pivot bushing 104 may be of any appropriate shape, size, type or configuration, such as of a generally cylindrical and tubular configuration. The pivot bushing 104 may be located at any appropriate position on the blending apparatus 10, such as located on and adjacent to a side of the motor mounting plate 98 opposite that of the slot 102 (FIGS. 7 and 8).

The drive plate 68 may also include a retainer 94 (FIG. 8). The retainer 94 may be of any appropriate shape, size, type or configuration, such as of a generally rectangle or square configuration. The retainer 94 may be located at any appropriate position, such as located on the drive plate 68. The retainer 94 may aid in securing the motor mounting plate 98 to the drive plate 68 within the housing 12.

Removal of the drive plate 68 and/or motor 100 may be accomplished by any appropriate means. For example, the drive plate 68 may be removed via fasteners, such as wing nuts or thumb screws, which may or may not require tools for removal. The side panel 22 closest to a tensioning mechanism may be removed in order to provide greater access to the motor 100 in order to access, remove or replace the motor 100.

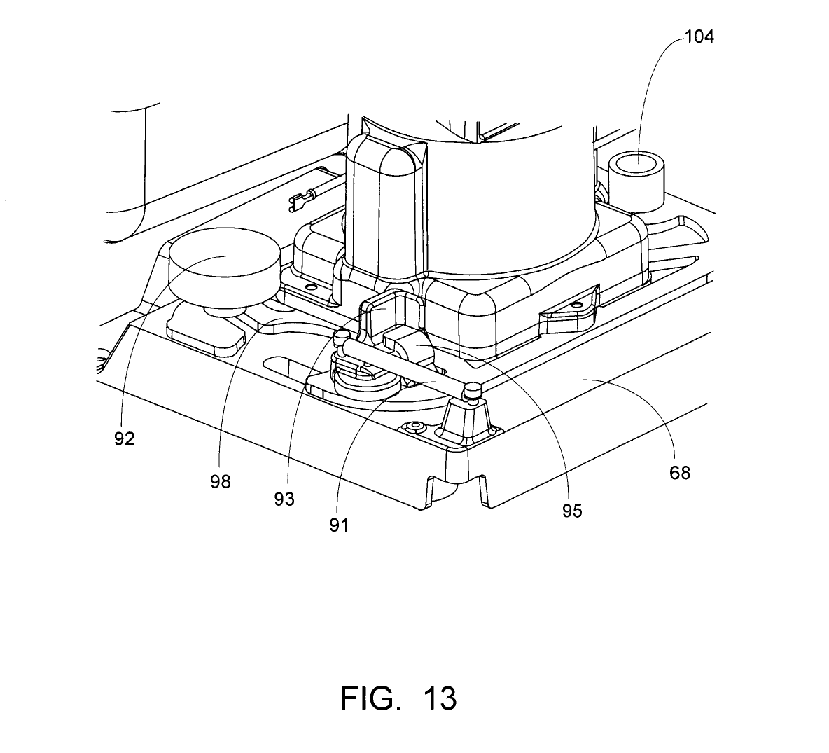

To remove and/or service the motor 100, the thumb screw 92 may be loosened and tensioning or spring mechanism may be unhooked. The drive plate 68 and motor 100 may then be slid or rotated towards the container housing 70, whereby the thumb screw 92 slides out from the slot 102. On the opposite side of the drive plate 68, as the drive plate 68 is moved towards the container housing 70 and away from the thumb screw 92, the drive plate 68 may also rotate on the pivot point 96 and move away from the retainer 94. The drive plate 68 and motor 100 may then be pulled upwards and away from the base plate 34 for service or removal. To assemble, the pivot bushing 104 may be aligned with the pivot point 96 and the thumb screw may be slid back into the slot 102. The holding system may provide for the motor 100 to be easily removed from the blending apparatus 10 for ease of service, which may provide for consistency of belt tension. Further, the motor may be set to the desired tension using the tensioning system (FIG. 13). The tensioning system may include a spring 91 connected between the motor mount plate 98 and the drive plate 68. The tension of the spring 91 may be adjusted using the tension lever 93. The lever 93 may be rotatable about a pivot point to add or decrease the belt tension. A hard stop 95 may be positioned along the travel path of the lever 93 to prevent over tensioning of the spring 91 and to mark the desired tension point for the system.

The blending apparatus 10 may include an interlock system (FIG. 6A). The interlock system may include an interlock rod 110, a mounting plate 112, a rod magnet 114 and a lid magnet 116 (FIG. 6A). The interlock system may act as a safety feature for the blending apparatus 10, whereby the interlock system may help maintain the lid 60 in a closed and locked position when the blending apparatus 10 is in use. In addition, the interlock system may stop any operations of the blending apparatus 10 when the lid 60 is opened.

The interlock rod 110 may be of any appropriate shape, size, type or configuration, such as of a generally cylindrical and tubular configuration. The interlock rod 110 may be located at any appropriate position on the blending apparatus 10, such as located within a corner of the shaver base 42 (FIG. 6A). The mounting plate 112 may be of any appropriate shape, size, type or configuration, such as of a generally rectangular or square planar configuration. The mounting plate 112 may be located at any appropriate position on the blending apparatus 10, such as adjacent the shaver base 42 (FIG. 8). The mounting plate 112 may secure or mount the interlock rod 110 to the shaver base 42.

The rod magnet 114 may be of any appropriate shape, size, type or configuration, such as of a generally cylindrical configuration. The rod magnet 114 may be located at any appropriate position on the interlock rod 110, such as near an upper end of the rod magnet 114 (FIG. 8). The lid magnet 116 may be of any appropriate shape, size, type or configuration, such as of a generally cylindrical configuration. The lid magnet 116 may be located at any appropriate position on the lid 60, such as within a corner of the lid 60 (FIG. 8). For example, the lid magnet 116 may be aligned with the rod magnet 114.

When the lid 60 is engaged with the ice bin 44, the attraction forces between the magnets 114, 116 may cause the rod 110 to move upwards. The mounting plate 112 may also include a sensor or read switch (not shown) that may be able to determine the position of the rod 110 (i.e. whether the rod is up or down), thereby determining when the lid 60 is attached or detached from the ice bin 44. The blending apparatus 10 may lock out use of selected or all components of the system when the lid 60 is removed from the ice bin 44. The mounting plate 112 may also include a dog leg. The dog leg may act as a stop to prevent the rod 110 from falling out of the shaver base 42, whereby the rod 110 may drop down and stop on the dog leg to stay within the shaver base 42.

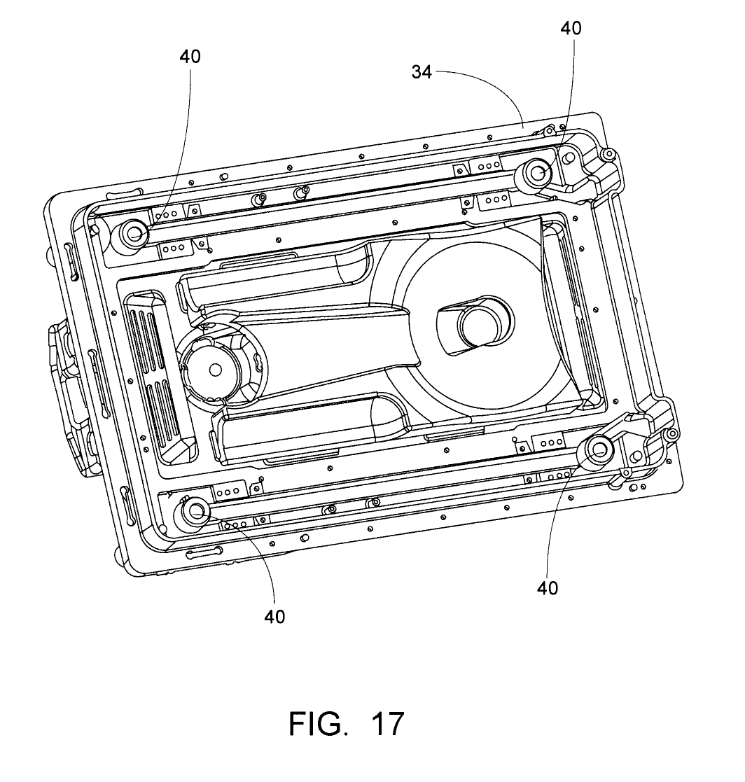

The blending apparatus 10 may include a weighing system. The weighing system may include at least one sensor or base plate load cell 38 and at least one sensor and/or shaver base load cell 56. The blending apparatus 10 may include any appropriate number of base plate load cells 38, such as three or more load cells 38 or four load cells 38 (FIG. 8). The load cells 38 may be of any appropriate shape, size, type or configuration. The load cells 38 may be located at any appropriate position on the blending apparatus, such as on each corner of the base plate 34 (FIG. 8). Each base plate load cell 38 may include a cell damper 40 generally located thereon (FIG. 8). The cell dampers 40 may be of any appropriate shape, size, type or configuration. Alternatively, the load cell 38 may be removed and replaced with only a damper 40 (FIG. 17).

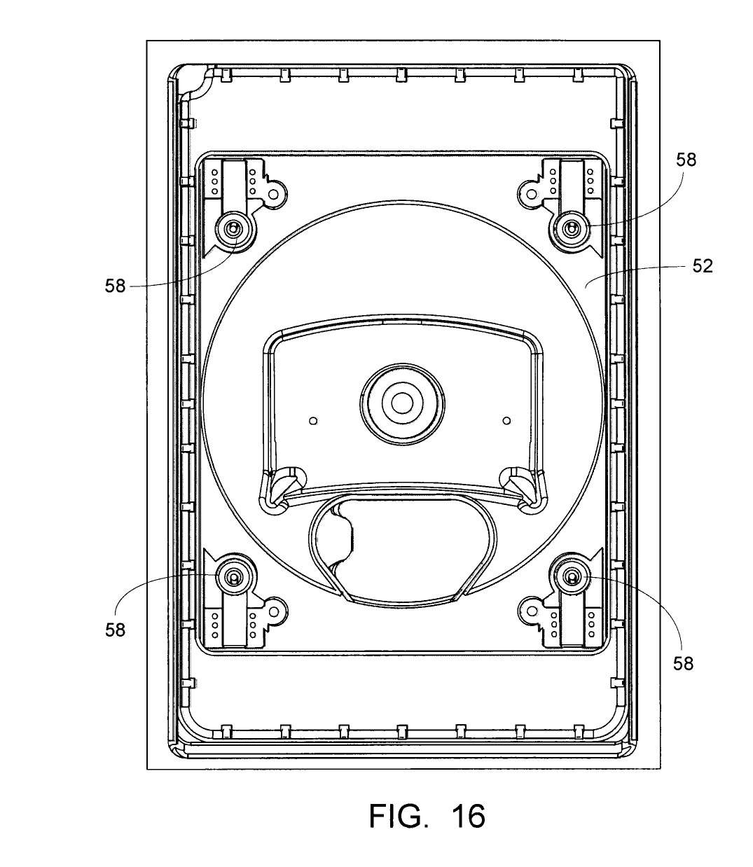

The blending apparatus 10 may include any appropriate number of shaver base load cells 56, such as three or more load cells 56 or four load cells 56 (FIG. 6A). The load cells 56 may be of any appropriate shape, size, type or configuration. The load cells 56 may be located at any appropriate position on the blending apparatus, such as on each corner of the shaver base 52 (FIG. 6A). Each shaver base load cell 56 may include a cell damper 58 generally located thereon (FIG. 6A). The cell dampers 58 may be of any appropriate shape, size, type or configuration. Alternatively, the load cell 56 may be removed and replaced with only a damper 58 (FIG. 16).

The blending apparatus may be configured to isolate the ice bin 44 from the drive plate 68 and container housing 70, such that the ice bin 44 may be weighed by the shaver base load cells 56 and the drive plate 68 and container housing 70 may be weighed by the base plate load cells 38. For example, the housing 12, including frame 14 and top frame 16, that supports the ice bin 44 may be arranged to be isolated from the load cells 38. The housing 12 may be supported directly by an outer lip of base plate 34 to distribute the weight of the ice bin 44 directly onto the base plate 34 and through the legs 36, thereby bypassing load cells 38. Accordingly, the base plate load cells 38 may be arranged to weigh only the drive plate 68 and container housing 70. Likewise, the shaver base load cells 56 may be arranged to weigh only the ice bin 44.

The weighing system may utilize any appropriate type of weighing method. For example, the weighing system may utilize an additive weighing method, a subtractive weighing method, or a combination of the two. For example, the drive plate 68 may be weighed by utilizing an additive weighing method. Here, the operator may tare out the weight before dispensing, whereby any ice added may be summed up. The added weight after you tare is how much ice has been dispensed. The load cells 38 may be mounted to the base plate 34 (FIG. 8). When weighing the base plate 34, the load cells 38 may also weigh everything attached to drive plate 68.

In another example, the ice bin 44 may be weighed by utilizing a subtractive weighing method. Here, the operator may tare out the ice bin 44 and then determine any drop or reduction in weight as the ice is dispensed. The load cells 56 may be moutned to the shaver base 52 (FIG. 6A). The weight removed from the ice bin 44 is equal to how much ice has been dispended.

In a further example, the operator may utilize both an additive weighing method and a subtractive weighing method. For example, the load cells 38 may measure the amount of mass added to the container 90 while the load cells 56 may measure the amount of ice dispersed from the ice bin 44. The weights from load cells 38 and 56 may be used as a check to verify measurements. The separate weights may also be used to measure the amount of both ice and another substance added to the container 90 while still measuring the amount of ice dispersed from the ice bin 44.

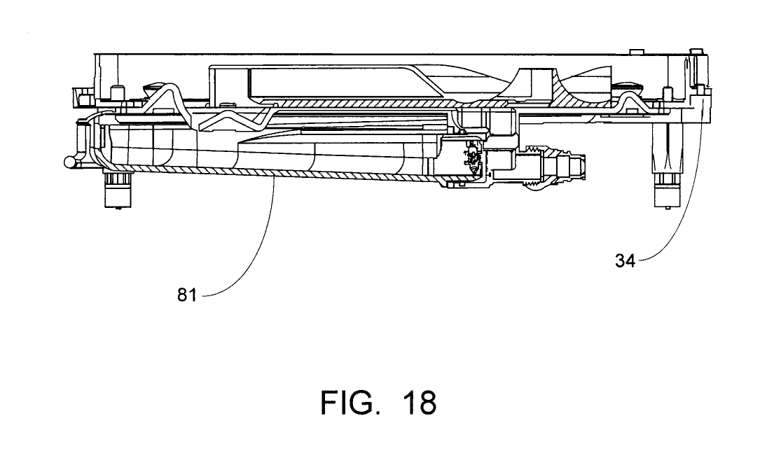

Utilizing weight to determine the amount of ice needed may permit the operator to make the same drink every time, since the operator is identifying the amount of ice needed by weight. In addition, by allowing the melted water in the ice bin 44 to drain from the ice bin 44 and out from the blending apparatus 10 into the drain cup 80 may further aid the sensors or load cells 38, 56 to accurately measure the ice in the shaver base 42. Alternatively, the cup 80 may be replaced with a tray 81 (FIG. 18). The tray 81 may be larger than the cup to hold a larger volume of drainage and may be connected, such as slidably connected, to the base plate 34 to allow for removal of the tray 81 and disposal of the drainage.

Although the embodiments of the present invention have been illustrated in the accompanying drawings and described in the foregoing detailed description, it is to be understood that the present invention is not to be limited to the embodiments disclosed, but that the invention described herein is capable of numerous rearrangements, modifications and substitutions without departing from the scope of the claims hereafter.

Having thus described the invention, the following is claimed:

1. A blending system comprising:
a base;
a housing connected to said base;
an ice bin positioned on top of said housing; and
three or more load cells positioned between said housing and said ice bin.

2. The blending system of claim 1, wherein said blending system includes four load cells positioned about said housing.

3. The blending system of claim 1 further comprising a shaver base positioned between said housing and said ice bin.

4. The blending system of claim 3, wherein said load cells are positioned on said shaver base.

5. The blending system of claim 4, wherein the shaver base is generally rectangular and further wherein a load cell is positioned near each corner of said shaver base.

6. The blending system of claim 1, wherein said blending system is configured to monitor said load cells to determine weight changes in said ice bin.

7. The blending system of claim 1 further comprising a shaver wheel located in said ice bin.

8. A blending system comprising:
a base;
a housing connected to said base;
an ice bin positioned on said housing;
a drive plate positioned on said base;
a container positioned on said drive plate and configured to receive ice from said ice bin; and
three or more load cells positioned between said base and said drive plate.

9. The blending system of claim 8 further comprising a shroud located on said drive plate and positioned about said container.

10. The blending system of claim 8, wherein said blending system is configured to monitor said load cells to determine weight changes in said container.

11. The blending system of claim 8 further comprising three or more ice bin load cells positioned between said housing and said ice bin.

12. The blending system of claim 11 further comprising a shaver base positioned between said housing and said ice bin.

13. The blending system of claim 12, wherein said ice bin load cells are located on said shaver base.

14. The blending system of claim 8 further comprising one or more dampers positioned between said ice bin and said shaver base.

15. A blending system comprising:
a base;
a housing connected to said base;
a shroud connected to said base;
a shaver base positioned above said housing;
an ice bin positioned above said shaver base, said ice bin having a shaver wheel therein;
wherein said shaver wheel includes a drain opening in fluid communication with one or more drain apertures in said shroud.

16. The blending system of claim 15, wherein said shroud includes two drain apertures.

17. The blending system of claim 15, wherein said drain apertures extend along a vertical edge of said shroud.

18. The blending system of claim 15, wherein said shaver base includes a pass-through portion to allow fluid to pass from said shaver wheel to said drain apertures.

19. A blending system comprising:
a base;
a shroud connected to said base, said shroud including at least one open side;
a first hinge located on a first side of said open side and a second hinge located on a second side of said open side;
a front door connected to said first hinge and said second hinge; and
wherein said front door is configured to pivot from both said first hinge or said second hinge.

20. The blending system of claim 19 comprising, wherein said front door includes a center portion and first and second hinged side portions on either side of said center portion and moveable with respect to said center portion.

21. The blending system of claim 19, wherein said hinges are magnetic.

22. The blending system of claim 19 further comprising an attachment portion connected to each hinged side portion, wherein said attachment portion is configured to engage said hinges.

23. A blending system comprising:
a base;
a drive plate positioned on said base, said drive plate comprising:
a pivot point;
a retaining member; and
a thumb screw;
a motor mount positioned on said pivot point and attached to said retaining member and clamped into a desired position by said thumb screw; and
a spring connecting said drive plate to said motor mount.

24. The blending system of claim 23 further comprising a slot in said drive plate configured to engage a portion of said thumb screw to allow pivotal movement of said drive plate.
